(19) United States
(12) Patent Application Publication
(10) Pub. No.: US 2017/0305482 A1
(43) Pub. Date: Oct. 26, 2017

(54) HEAVY LOAD TRANSPORT VEHICLE OF VARIABLE WIDTH

(71) Applicant: Scheuerle Fahrzeugfabrik GmbH, Pfedelbach (DE)

(72) Inventors: Sven Nabeck, Pfedelbach (DE); Reinhard Hauf, Pfedelbach (DE)

(21) Appl. No.: 15/621,090

(22) Filed: Jun. 13, 2017

Related U.S. Application Data
(63) Continuation of application No. PCT/EP2016/000540, filed on Mar. 31, 2016.

(30) Foreign Application Priority Data
Apr. 8, 2015 (DE) 10 2015 004 288.2
Apr. 8, 2015 (DE) 20 2015 002 529.3

(51) Int. Cl. B62D 53/06

(52) U.S. Cl. CPC B62D 53/067; B62D 53/061

(57) ABSTRACT

A heavy load transport vehicle of variable width has a chassis which has two chassis parts which each support a number of wheel arrangements arranged one behind another, wherein the two chassis parts define a transport platform for the heavy load to be transported. The transport vehicle may have a wheel-free central chassis part arranged between said two lateral chassis parts, and that at least one lateral chassis part is pivotable about a pivot axis in relation to the central chassis part.

### CROSS-REFERENCE TO RELATED APPLICATIONS

This continuation application claims priority to PCT/EP2016/000540 filed on Mar. 31, 2016 which has published as WO 2016/162115 A1 and also the German application numbers 10 2015 004 288.2 filed on Apr. 8, 2015 and 20 2015 002 529.3 filed on Apr. 8, 2015, the entire contents of which are fully incorporated herein with these references.

### DESCRIPTION

### Field of the Invention

The invention relates to a heavy load transport vehicle with a variable width, comprising a chassis having two chassis parts, each carrying a number of successively arranged wheel assemblies, the two chassis parts defining a transport platform for the heavy load to be transported.

### Background of the Invention

Such a transport vehicle is known from WO 2014/090407 A1 of the applicant. For transporting loads with excessive width and for driving back without load respectively it is of advantage if the width and the track width of the vehicle used for transportation can be changed. Furthermore—e.g. in some federal states of the U.S.A.—there exist legal provisions for transport vehicles for the transportation of loads with an extra weight, by which the allowable load per axle is a limited, depending on the track width of the vehicle, so that a variable track width is of advantage in order to meet the legal provisions and to exploit the maximum axle load.

In the transport vehicle known from the aforementioned document it is provided that, for varying the width and the track width, the two chassis parts each carrying a number of successively arranged wheel assemblies can be adjusted traverse to a longitudinal center plane for varying the width of the transport vehicle. For this purpose, the track rods of the wheel assemblies must be adjusted too.

Transport vehicles with a width and a track width, which can be changed if required, are known, besides from the document referenced at the beginning, from e.g. U.S. Pat. Nos. 4,772,038, 5,118,245 or 5,426,128 too.

U.S. Pat. No. 3,339,942 discloses a low loader with variable track width, whose width can be reduced when driving empty. The low loader comprises two pairs of rigid axles, the front pair of axles being connected rotatably via a goose neck with the tractor and the rear axle pair being connected via a second goose neck rotatably with the first goose neck, in order to improve the maneuverability of the low loader.

From U.S. Pat. No. 4,221,398 a transport vehicle of the type mentioned at the beginning is known, having the form of a drawbar trailer and a low loader with multiple steering axles, whose width and track width can be increased and decreased respectively, if required, by moving the two chassis parts, each carrying a row of wheel assemblies, traverse to the direction of travel and to a vertical longitudinal middle plane of the transport vehicle respectively, apart or together.

From U.S. Pat. No. 3,810,660 a foldable cart for an agricultural rake is known. The cart comprises a central triangular chassis with an axle having two wheels. On each side of the chassis a rake, which can be folded upwards, is arranged, each having on its outer end a support wheel. The described design achieves that in the driving mode both rakes can be folded upwards, so that the width of the vehicle formed by the chassis and the two rakes can be reduced.

U.S. Pat. No. 4,772,038 shows a trailer having a middle chassis part as well as two lateral chassis parts. For changing the width of the trailer, the two lateral chassis parts can be moved relative to the central chassis part.

Starting from this, it is the object of the invention to further develop a transport vehicle of the afore-mentioned kind so that in particular a smaller width of the transport vehicle when driving empty, compared to its loaded state, is achieved.

This object is achieved according to the invention in that the transport vehicle comprises a central chassis part with no wheels being arranged between the two lateral chassis parts, and that at least one lateral chassis part can be pivoted about a pivot axis relative to the central chassis part.

Advantageous further developments of the invention are the subject matter of the dependent claims.

### SUMMARY OF THE INVENTION

By virtue of the aforementioned measures in an advantageous manner a transport vehicle is provided, which is characterized in that its width can be reduced in a simple manner by pivoting the two lateral chassis parts being hinged to the central chassis part, so that by lifting the central chassis part the two lateral chassis parts can be pivoted, preferably downwards. The transport vehicle according to the invention therefore can, after the completion of its transport task, transported back by loading the folded transport vehicle on the platform of a transport-back-vehicle.

An advantageous further development of the invention provides that at least one lateral chassis part is formed variable in its width. Such a measure has got the advantage that in this way the width and the track width of the inventive transport vehicle for the transportation of a heavy and/or bulky load can be enlarged. After the completion of the transport task then the one or the widened lateral chassis parts are pushed together and are pivoted as described, so that such a configured transport vehicle can be easily transported back.

A further advantageous further development of the invention provides that the transport vehicle comprises a number of support assemblies, which are arranged on the lateral chassis parts, protrude from the lateral chassis parts outwardly and are provided on their outer ends with rolling or sliding elements. Such a measure has got the advantage that in this way the folding and unfolding, respectively, of the lateral chassis parts during the transition between a transport configuration of the inventive transport vehicle, in which the lateral chassis parts are unfolded, into a transport-back-configuration, in which the lateral chassis parts are folded, is eased in that the lateral chassis parts roll or slide on the support assemblies during that transition.

A further advantageous embodiment of the invention provides that at least one support assembly has got at least two support elements, which protrude from the lateral chassis parts. Such a measure has got the advantage that in this way an improved support of the lateral chassis parts is achieved when folding or unfolding.

A further advantageous further development of the invention provides that the one or at least one of the support assemblies are removably mounted on the transport vehicle. This has the advantage that the support assemblies only have to be provided during the aforedescribed transition from the transport configuration into the transport-back-configuration on the transport vehicle according to the invention.

### BRIEF DESCRIPTION OF THE DRAWINGS

Further details and advantages of the invention are disclosed in the exemplary embodiments, which are described below with reference to the figures. It shows:

FIG. 1 is an isometric view of a first exemplary embodiment of a transport vehicle in its transport configuration;

FIG. 2 is a front view of the first exemplary embodiment of FIG. 1;

FIG. 3 is an isometric view of the transport vehicle of FIG. 1 in its transport-back-configuration;

FIG. 4 is a front view of the first exemplary embodiment of FIG. 3;

FIG. 5 is the first exemplary embodiment of the transport vehicle in a partially folded position;

FIGS. 6a to 6d are a schematic representation of the transition from the transport configuration to the transport-back-configuration;

FIG. 7 is a detail of the first exemplary embodiment;

FIG. 8 is an isometric view of a second exemplary embodiment of a transport vehicle in its transport configuration;

FIG. 9 is a front view of the second exemplary embodiment of FIG. 8;

FIG. 10 is an isometric view of the transport vehicle in its transport-back-configuration;

FIG. 11 is a front view of the second exemplary embodiment;

FIG. 12 shows the second exemplary embodiment of the transport vehicle in a partially folded position;

FIGS. 13a to 13d are a schematic representation of the transition from the transport configuration to the transport-back-configuration; and

FIG. 14 is a detail of the second exemplary embodiment.

### DETAILED DESCRIPTION OF THE PREFERRED EMBODIMENTS

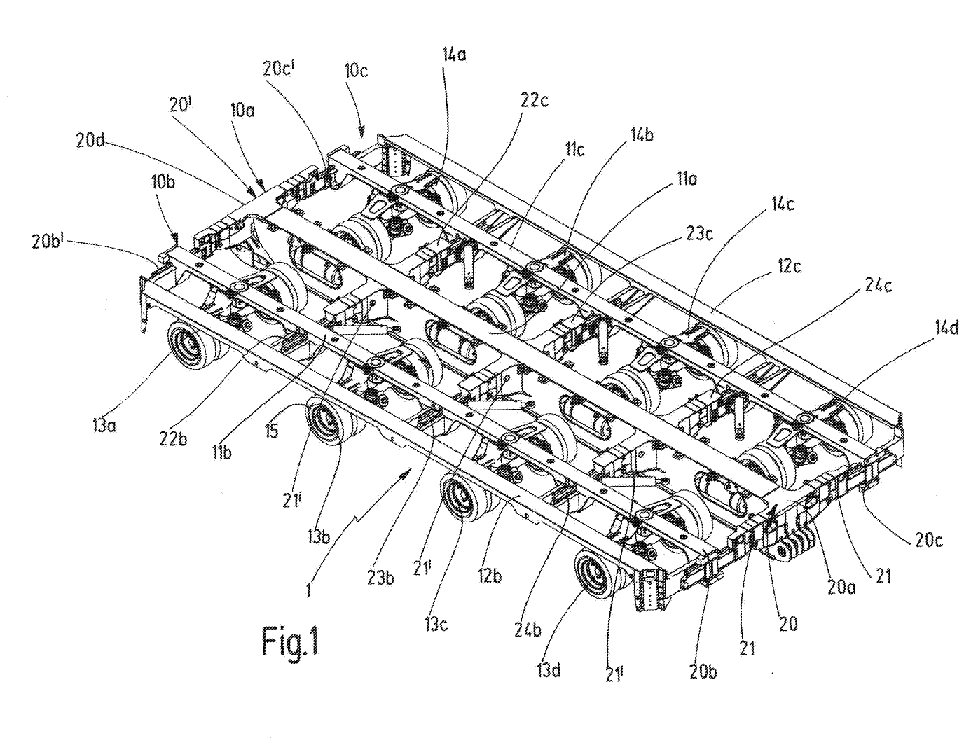

In FIGS. 1 to 6 a first exemplary embodiment of a transport vehicle, generally designated with 1, is shown. The transport vehicle 1 is formed, in the described exemplary embodiment, as a platform trailer, which is towed by a towing vehicle, not shown. However, it is possible to form the transport vehicle 1 of FIG. 1 as a self-propelled transport vehicle. It is evident for the person skilled in the art which changes he has got to make in that case, so that these need not to be described.

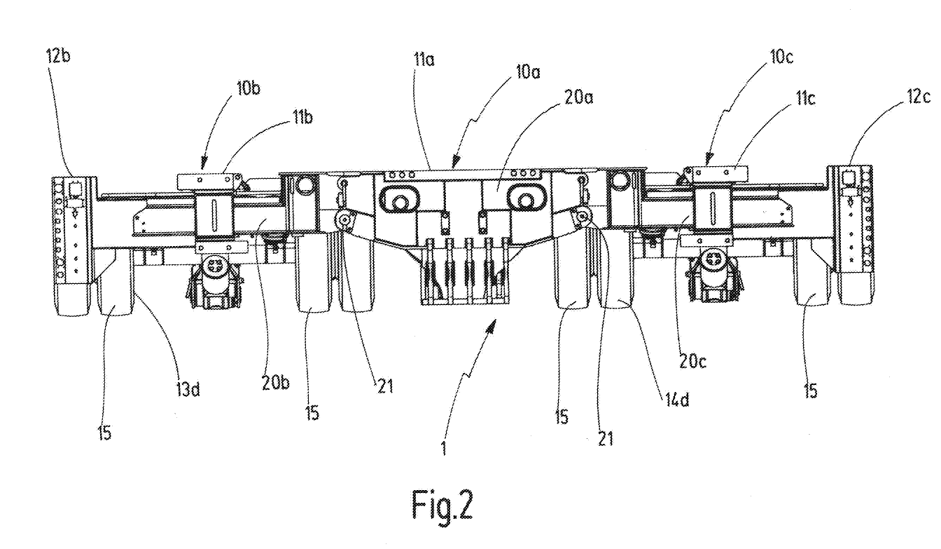

The transport vehicle 1 has, at least in its transport configuration shown in FIGS. 1 and 2, an extra width. This makes it possible to transport with this heavy load transport vehicle loads with an excess width, e.g. machine housings, transformer housings, domes of wind turbines, turbine casings or turbines or the like. It is evident for the person skilled in the art that for the understanding of the following description of the transport vehicle 1 it is not important which load is to be transported by the transport vehicle 1.

After the transport vehicle 1 has carried out the transport task to be accomplished, such a transport vehicle 1 generally must be transported back to its starting point or to a different location. Road transport with an excess width are always complex as significant legal requirements have to be met for safety reasons, e.g. that a certain speed limit must be observed, that the driving on public roads is only allowed at certain times, that such a road transport with an excessive width must be accompanied by security vehicles, etc. When driving the transport vehicle 1 empty to its starting point or to a different location the transport vehicle 1 does not bear a heavy load any longer so that a return of the same with the excessive width required for the transportation of the load would cause an unnecessary expenditure. For this reason, as described at the beginning, the transport vehicles' width and/or the track width is reduced. For the known transport vehicles, the back transport is done up to now in such a way that the transport vehicle, having its width and track width reduced, is transported back on its own wheels by a towing vehicle.

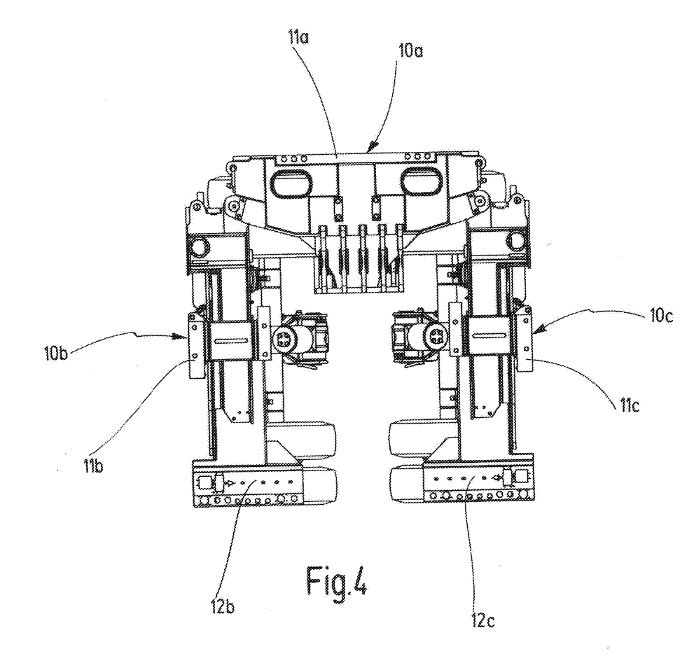

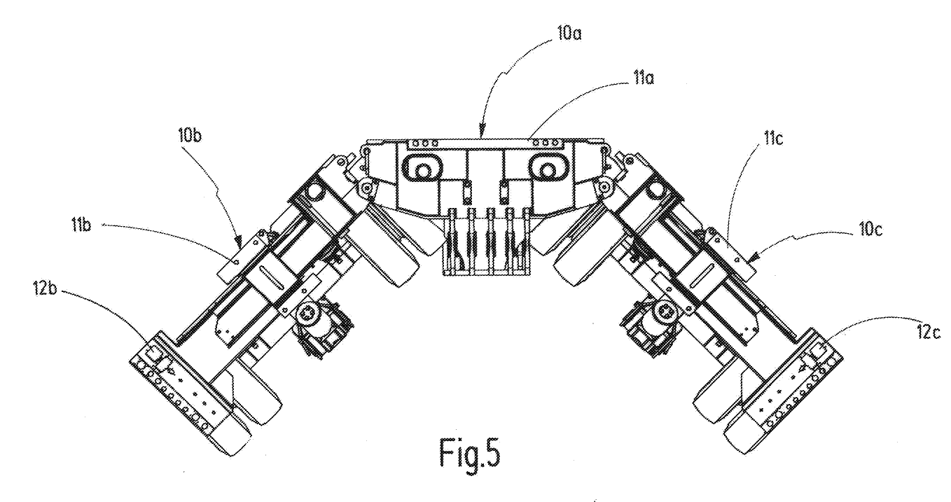

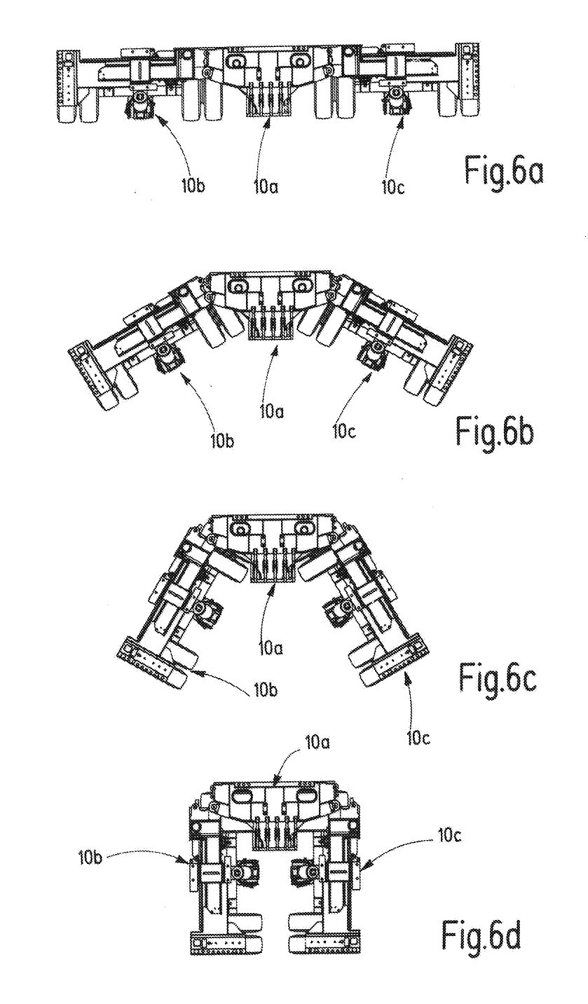

In order to provide an easier way of a back transport, the described transport vehicle 1 provides that the chassis 10 has got a central chassis part 10a and two lateral chassis parts 10b and 10c. The two chassis parts 10b, 10c define a transport platform for the heavy load to be transported. These two lateral chassis parts 10b, 10c are pivotally arranged relative to the central chassis part 10a, as shown in FIGS. 6a-6d. In this way the width of the transport vehicle 1 can be reduced in a simple way and the transport vehicle 1 can be easily transported back, preferably on the load platform of a transport-back-vehicle. FIGS. 4 and 5 show the transport vehicle 1 in such a transport-back-configuration. It can be seen that the two lateral chassis parts 10b, 10c are folded downwards in respect to the central chassis 10a, so that a compact state of the transport vehicle 1 is provided. It is possible too that the two lateral chassis parts 10b and 10c are pivoted in respect to the central chassis part 10a upwardly. In the following, the further description of the transport vehicle 1 is done under the assumption that the two lateral chassis parts 10b and 10c can be folded downwardly. It is evident for the person skilled in the art what modifications he would have to make when the last mentioned configuration—the lateral chassis parts 10b and 10c are folded upwardly—is to be achieved.

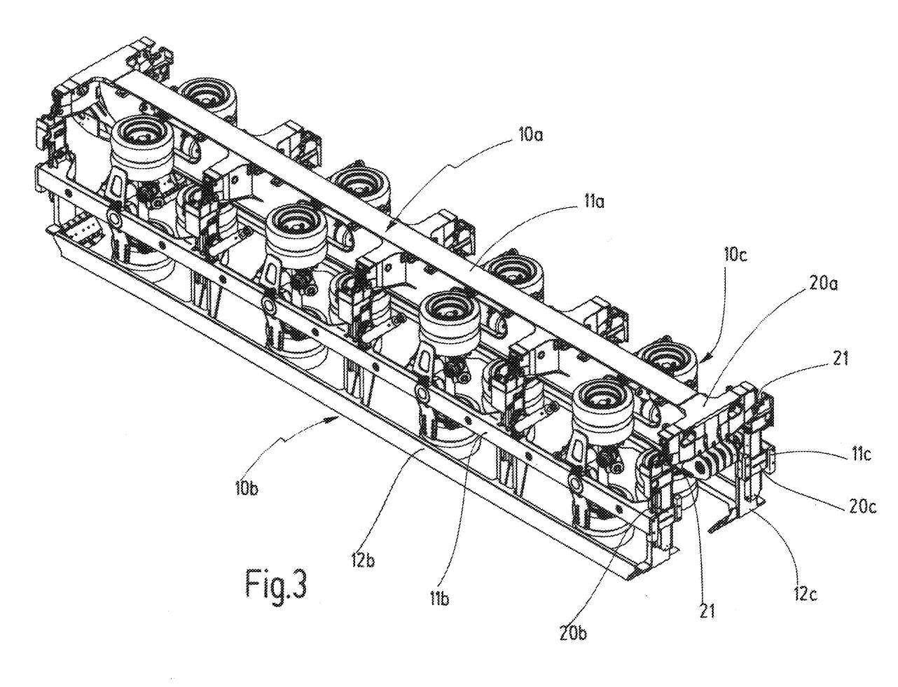

As shown particularly in FIGS. 1 and 3, the central chassis part 10a comprises a central longitudinal carrier 11a, with cross members 20 and 20′ being arranged at its front and its rear end respectively.

Each of the two lateral chassis parts 10b and 10c comprises a lateral longitudinal carrier 11b and 11c respectively. Preferably it is provided that each of the lateral chassis parts 10b, 10c of the transport vehicle 1 comprises an outer longitudinal carrier 12b, 12c too, which form the outer boundaries of the two lateral chassis parts 10b and 10c. The use of such outer longitudinal carriers 12b and 12c furthermore has got the advantage that in this way—as best seen in FIG. 6d—a support for the folded transport vehicle 1 is provided, which makes it possible in a simple way to transport the folded transport vehicle 1 onto a transport platform of a transport-back-vehicle.

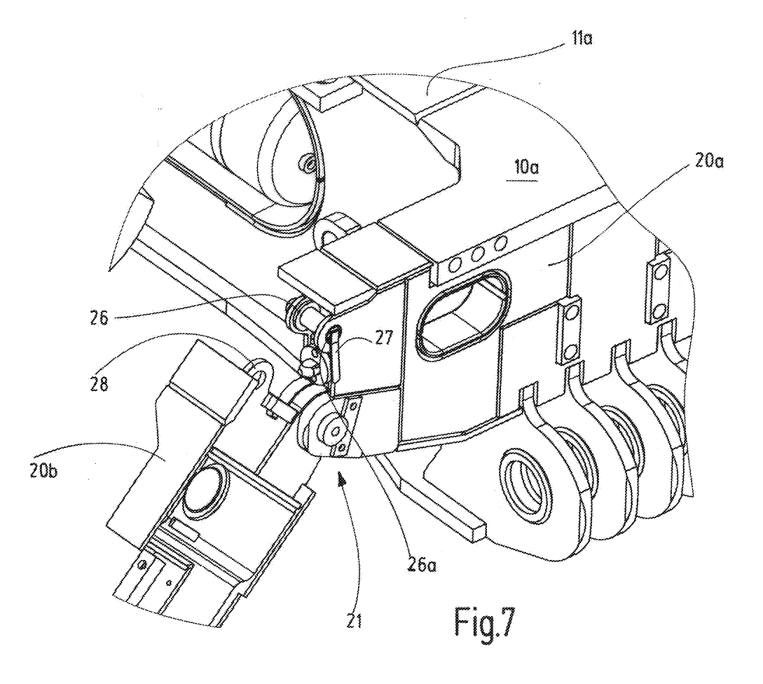

The first cross member 20 comprises—like the second cross member 20′—a central cross member segment 20a, which is connected with the central longitudinal carrier 11a of the central chassis part 10a. Two lateral cross member segments 20b and 20c and 20b′ and 20c′ respectively are connected with the central cross member segment 20a and 20a′ respectively via hinges 21, which are shown in FIG. 7. The first lateral longitudinal carrier 11b and the first outer longitudinal carrier 12b of the first lateral chassis part 10b are connected with the first lateral cross member segments 20b and 20c′, the second lateral longitudinal carrier 11c and the second outer longitudinal carrier 12c are in turn connected with the second cross member segment 20b and 20c′ of the cross members 20 and 20′ respectively. By means of a connection of the afore-mentioned parts a stabile transport surface of the transport vehicle 1 is defined.

On both sides of the central longitudinal carrier 11a a corresponding number of further cross members, in the embodiment shown here three cross members 22b-24b and 22c-24c, are arranged, whereby corresponding cross members preferably are aligned. The further cross members 22b-24b and 22c-24c respectively each connect the central longitudinal carrier 11a with the lateral longitudinal carriers 11b and 11c respectively and the outer longitudinal carriers 12b and 12c respectively.

Each further cross member 22b-24b and 22c-24c has a hinge 21′ too, by which it is connected with the central chassis part 10a and—as shown here—in particular with the longitudinal carrier 11a of said central chassis part 10a pivotally. The first lateral chassis part 10b and/or the second lateral chassis part 10c therefore can be pivoted around pivot axes 22c-24c by the respective hinges 21 of the cross members 20 and 20′ as well as the hinges 21′ of the further cross members 22b-24b, as it is shown in FIGS. 6a-6d.

This allows it to pivot the lateral chassis parts 10b, 10c from their transport configuration shown in FIGS. 1 and 2, in which the transport vehicle 1 has got the platform being defined by the longitudinal carriers 11a, 11b, 11c as well as the outer longitudinal carriers 12b and 12c, into the configuration shown in FIGS. 3 and 4, in which the width of the transport vehicle 1 is substantially reduced. It therefore can be loaded on a transport-back-vehicle serving for its return and can be transported to its starting position or to its next place of usage. The transport of the described transport vehicle 1 in such a piggyback method, in which the transport vehicle 1 is transported as a load of the transport-back-vehicle, has got the advantage that in this case during the road transport no longer the more stringent legal requirements for road transport with excessive width, but the legal requirements for the load transport of the transport-back-vehicle apply.

The transition from the transport configuration shown in FIGS. 1 and 2 in the return transport configuration shown in FIGS. 3 and 4 is performed in such a way that the transport vehicle 1 is lifted by a crane or a similar lifting device. For this purpose, the transport vehicle 1 comprises means, which are known for itself and hence are not described in detail, by means of which the crane or another lifting device can engage on the central chassis part 10a and can lift it.

A lifting of the central chassis part 10a effects that—as shown in FIG. 5 as well as in FIG. 6b—the lateral chassis parts 10b and 10c are moved around axes defined by the hinges 21, 21′ downwardly, until they finally reach their position shown in FIG. 6d. After they have been secured, preferably by not shown locking means, against an unintentional unfolding, the transport vehicle 1 can be lifted onto the platform of an appropriate vehicle and the return transport can take place.

As it can be seen from FIG. 6d, the outer longitudinal carriers 12b and 12c provide a standing surface for the folded transport vehicle 1, which allows it in an advantageous manner to position the transport vehicle 1 in its return transport configuration on the load surface of an appropriately equipped transport-back-vehicle.

The transfer of the folded transport vehicle 1, which is in its transport-back configuration, into its transport configuration then is done in an inverse order of the sequence of FIG. 6a-6d. The transport vehicle 1 is lifted by a crane or another lifting device from the load surface of the transport-back-vehicle. Then the lateral chassis parts 10b and 10c are pulled apart in a transverse direction and the central chassis part 10a is further lowered, until finally the transport vehicle 1 has got its transport configuration shown in FIG. 6a.

In the case described here, the transport vehicle 1 is designed to be variable in its width and track width. For this purpose, it is provided that the cross member segments 20b, 20b′ and 20c, 20c′ as well as the further cross members 22b-24b, 22c-24c are formed telescopable, so that by a corresponding change of the length of the lateral cross member segments 20b, 20b′, 20c, 20c′ as well as of the further cross members 22b-24b, 22c-24c the width and the track width of the chassis parts 10b and 10c and hence the width of the transport vehicle 1 can be changed. Such a variability of the width and the track width of the transport vehicle 1 is advantageous, but not mandatory. It can be provided too, that the lateral chassis parts 10b and 10c have got a pre-defined width, so that in this case a telescopability of the lateral cross member segments 20b, 20b′, 20c, 20c′ as well as the further cross members 22b-24b, 22c-24c is not required.

Each of the lateral chassis parts 10b and 10c has a number of wheel assemblies 13a-13d and 14a-14d respectively, which are preferably designed as pendulum axles and furthermore preferably have a hydraulic suspension. The formation of such wheel assemblies is known and needs not to be described in detail. In the case shown here, the wheel assemblies 13a-13d and 14a-14d are formed as wheel axles, which are arranged on the lateral longitudinal carriers 11b and 11c respectively and each have two dual wheels 15. However, it is possible that the wheel assemblies 13a-13d and 14a-14d respectively comprise instead of axle lines single wheel suspensions. The central chassis part 10a being arranged between the two lateral chassis parts 10b and 10c does not have—as it can be seen from the Figures—such wheel assemblies, it is therefore “wheel-less”. It is preferred that the wheel assemblies 13a-13d and 14a-14d respectively are formed, at least partially, as steering axles. This is also known and therefore needs not to be explained in more detail.

The formation of the pivotal connection between the central chassis part 10a and the lateral chassis parts 10b and 10c respectively is explained exemplarily with reference to FIG. 7, which, in part, shows a top view on the respective end portions of the transport vehicle 1. One recognizes the end of the central longitudinal carrier 11a, the left end of the cross member 20a connected with it, the hinge 21 and the inner end portion of the lateral cross member segment 20b of the cross member 20, which is connected via the hinge 21 with the end of the central cross member segment 20a. This one has got a first locking element 26 with a through hole 26a for a hinge bolt 27. The cross member segment 20b comprises a second locking element 28 formed complementary to the first locking element 26, which can be inserted between the lamellae of the first locking element 26. If the hinge bolt 27 is led through the aligned openings of the two locking elements 26, 28, a stabile locking of the pivotal connection is formed.

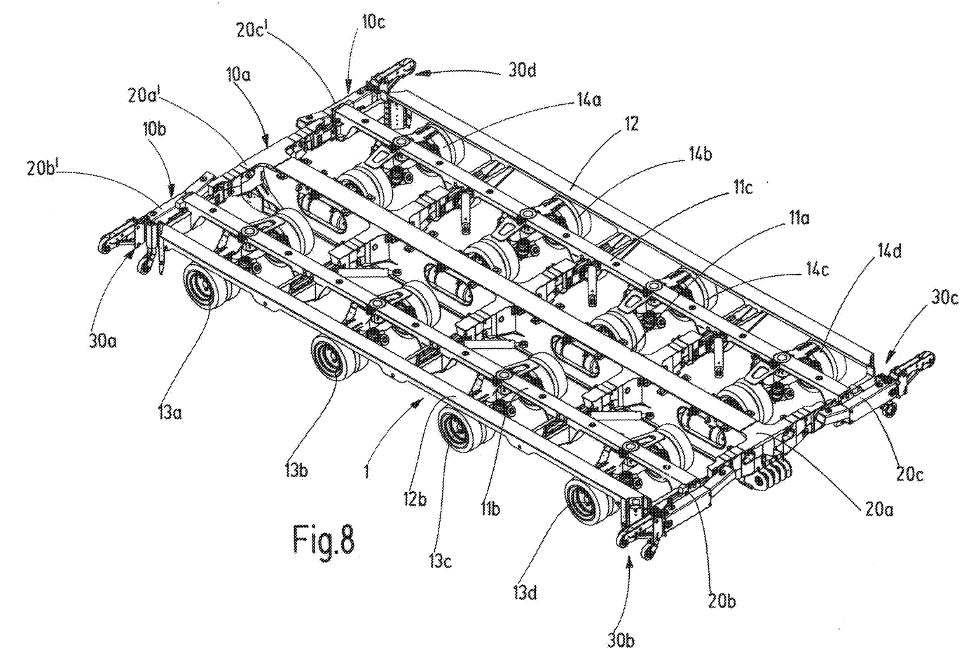

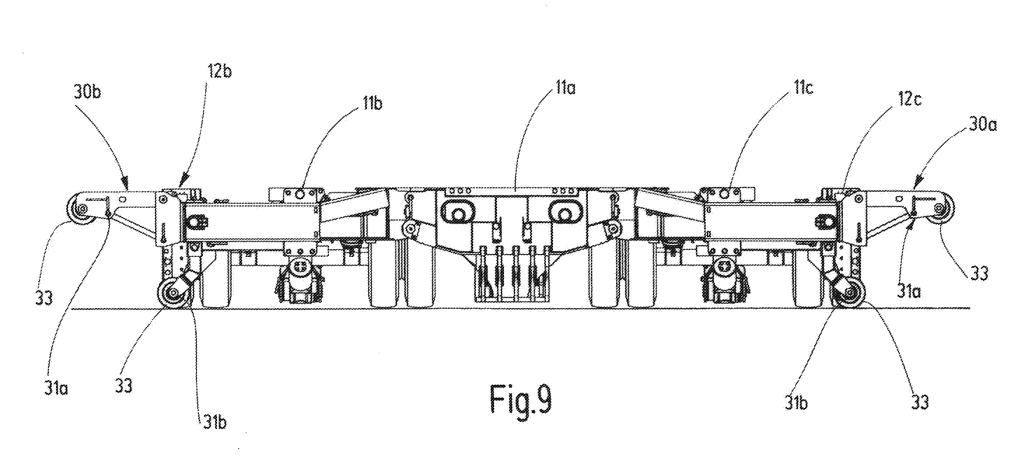

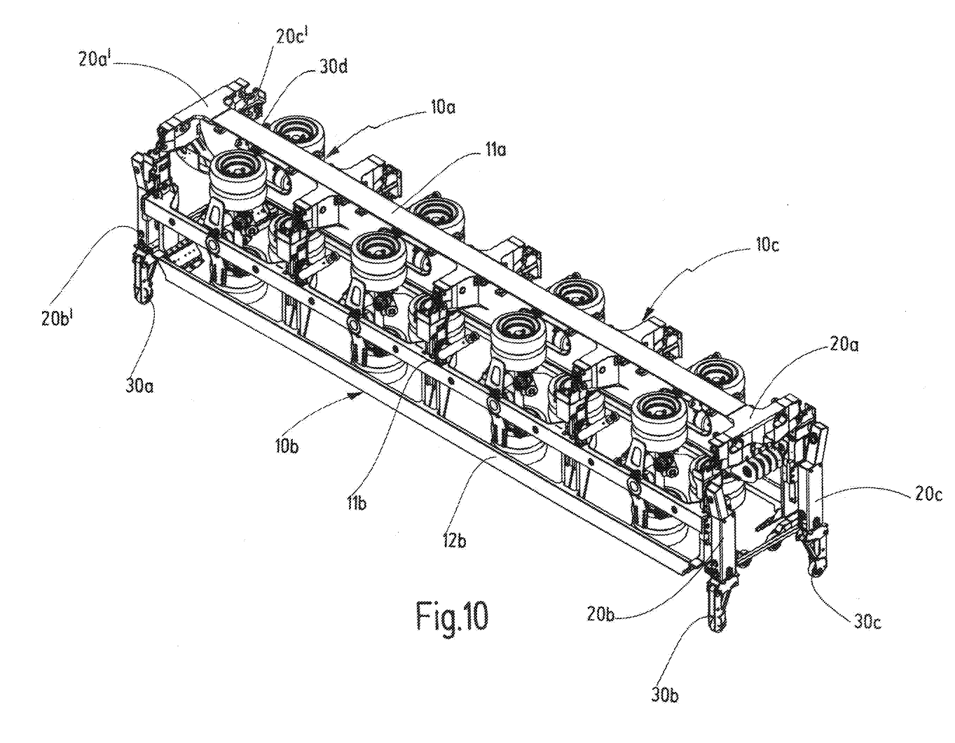

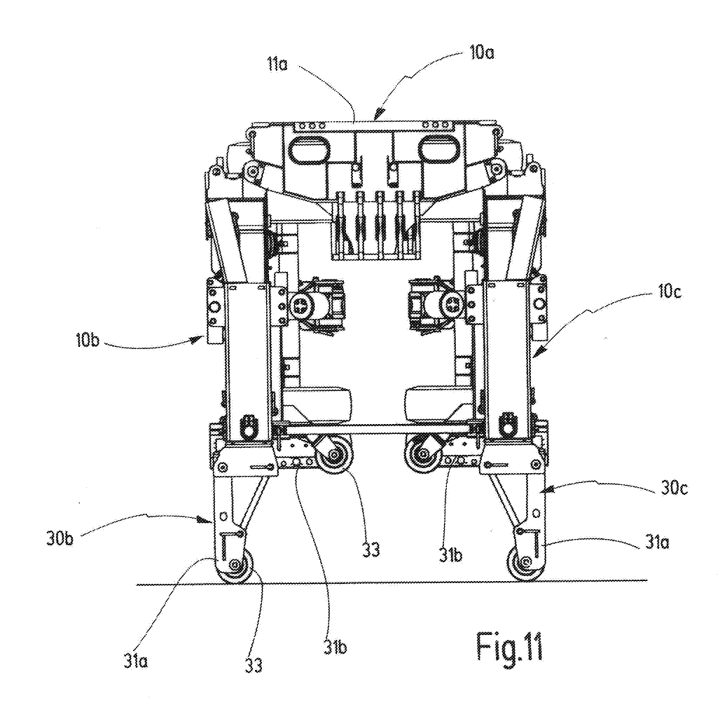

In FIGS. 8 to 14 a second exemplary embodiment of a transport vehicle 1 is shown, whose basic design corresponds to the one of the first exemplary embodiment. Corresponding components are therefore provided with the same reference signs and are not described in detail any more.

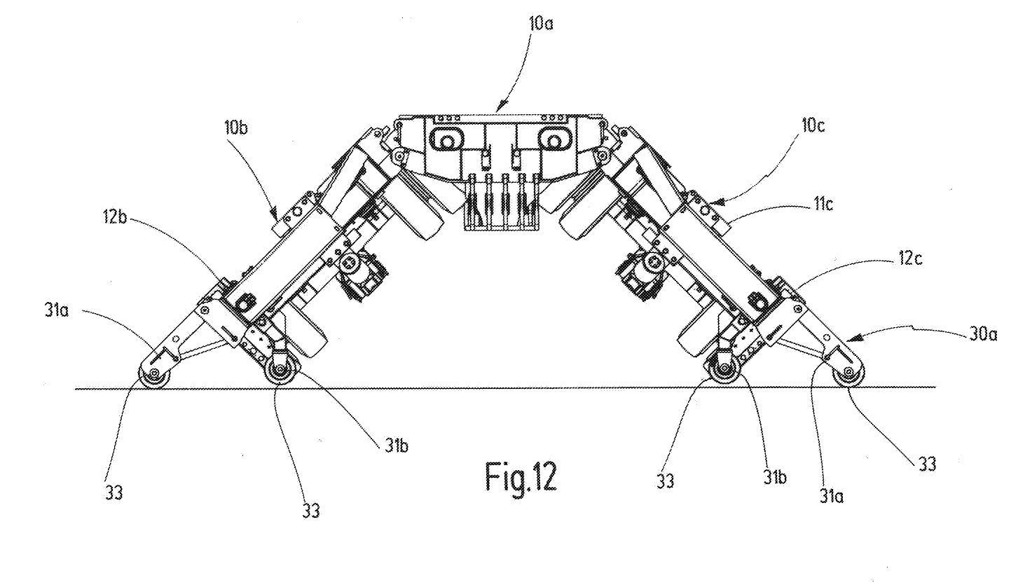

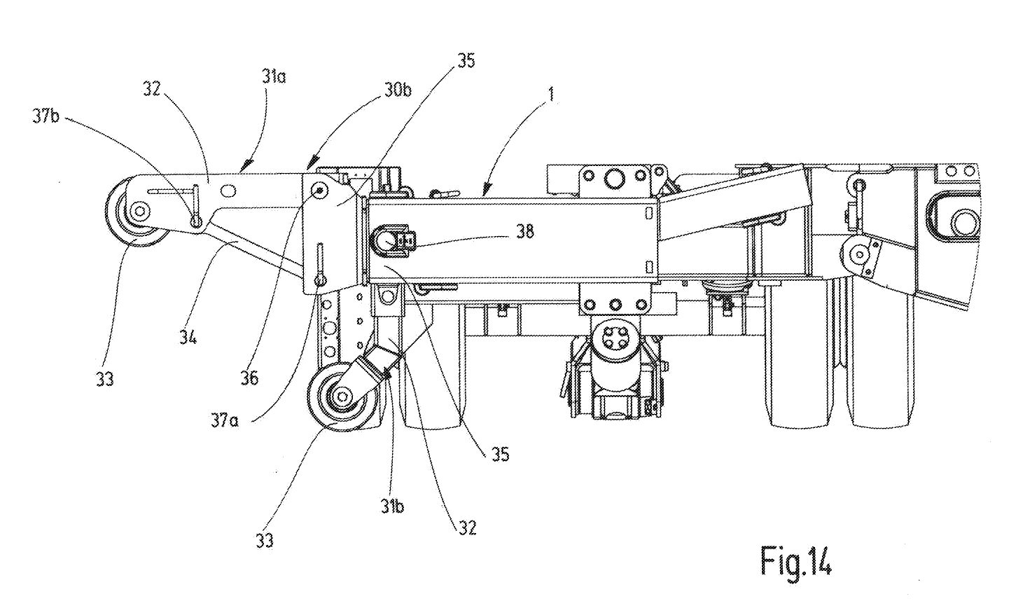

The main difference between the two exemplary embodiments is that the transport vehicle 1 according to the second exemplary embodiment has got a number of support assemblies 30a-30d, which serve to facilitate the transition of the transport vehicle 1 between its transport configuration and its return-configuration and vice versa. The support assemblies 30a and 30b are arranged on the outer longitudinal carrier 12b and the support assemblies 30c and 30d are provided on the second outer longitudinal carrier 12c. The design of the support assembly 30b is described with reference to FIG. 14, the other support assemblies 30a, 30c, 30d are preferably designed in the same way as the support assembly 30a. Each support assembly 30a-30d comprises a first support unit 31a with an arm 32, which is connected by its first end to the respective outer longitudinal carrier 12b and 12c respectively. At its second end the arm 32 carries a roll 33. It should be noted that the use of a roll 33 is preferred, but not mandatory. As it can be seen from the following description of the folding process of the two lateral chassis parts 10b and 10c in respect to the central chassis part 10a, instead of the rolls 33 a sliding element or the like can be used too. A support element 34 connects the arm 32 of the first support unit 31a with the outer longitudinal carrier 12a and 12b respectively. Preferably it is provided that the first support unit 31a of the support assembly 30a is arranged detachably on the transport vehicle 1. Such a measure has got the advantage that the support assembly 30a as well as the further support assemblies 30b-30d need not to be permanently attached to the transport vehicle 1, but only can be attached to it, when this is required, namely for folding and unfolding of the lateral chassis parts 10b and 10c. For this purpose it is preferred that on the outer longitudinal carrier 12b and 12c respectively a receptacle 35 is provided, in which the arm 32 of the first support unit 31a can be inserted and fixed there by means of a locking element 36, e.g. a bolt. It is preferred that the support element 34 too—as shown in FIG. 12—engages with its first end on the receptacle 35 and with its second end on the arm 32, whereby the fastening of this detachable support element 34 is done by two locking elements 37a and 37b.

The support assembly 30 preferably comprises a second support unit 31b, which has got an arm 32 too, which engages with its first end on the outer longitudinal carrier 12a and 12b respectively and bears on its second end a roll 33 or a sliding element. Preferably this second support unit 31b is formed detachable. For this purpose the arm 32 of the second support unit 31b is inserted in a further receptacle 35′ of the transport vehicle 1 and is fastened there via a locking element 38.

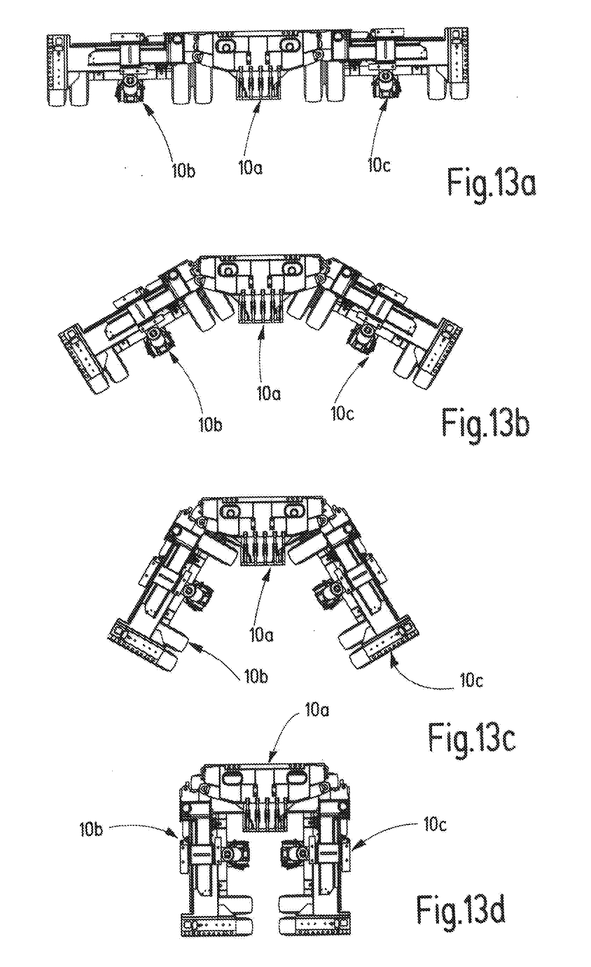

The pivoting of the two lateral chassis parts 10b, 10c in respect to the central chassis part 10a is described with reference to the sequence of the FIGS. 13a-13d: FIG. 13a shows the transport vehicle 1 in its transport configuration, but the first support assemblies 30a-30d have already been mounted on the transport vehicle 1. The first support units 31a of the support assemblies 30a-30d protrude laterally from the transport vehicle 1, wherein it is preferred that said first support units 31a are generally arranged horizontally. The second support units 31b of the support assemblies 30a-30d are preferably arranged such that their rolls 33 rest on the ground bearing the transport vehicle 1, they are preferably arranged substantially vertical.

If now the central chassis part 10a is lifted by means of a crane or a similar lifting device, the two lateral chassis parts 10b and 10c pivot according to the lifting of the central chassis part 10a downwardly, wherein the two lateral chassis parts 10b and 10c roll on the rolls 33 of the second support unit 31b of the support assemblies 30a-30d (FIG. 13b). A further lifting of the central chassis part 10a causes the rolls 33 of the first support units 31a of the support assemblies 30 to engage on the ground bearing the transport vehicle 1. The rolls 33 of the second support units 31b then lift off the ground and the two lateral chassis parts 10b, 10c then roll onto the rolls 33 of the first support units 31a of the support assemblies 30.

As it is evident from FIG. 13c, the two lateral chassis parts 10b and 10c are supported at the end of the lifting process of the central chassis part 10a by the rolls 33 of the first support units 31a of the support assemblies 30a-30d.

Then the first support units 31a of the support assemblies 30 are folded, until they reach their position shown in FIG. 13d. The thus folded transport vehicle 1 is ready for its return transport.

In conclusion, it has to be stated that by the described measures in an advantageous manner a transport vehicle 1 is provided, whose width can be reduced in a simple manner in that at least one and preferably both of its lateral chassis parts 10b, 10c are pivoted around a pivot axis in respect to the central chassis part 10a, i.e. that the two lateral chassis parts 10b and 10c are folded around the respective hinge axis, so that these ones, in the back-transport-mode of the transport vehicle 1, preferably are located within the width defined by the width of the central chassis part 10a. The transport vehicle 1 therefore can be placed in a simple manner on a platform vehicle and can be transported in this state to its starting point or to a further point of employment.

The optionally provided support assemblies 30a-30d facilitate here the transition between the transport configuration and the transport-back-configuration (and vice versa), since in this case the lateral chassis parts 10b and 10c can roll on rolls 33 of the support assemblies 30a-30d.

What is claimed is:

1. A heavy load transport vehicle with a variable width, comprising:
a chassis having two lateral chassis parts, each lateral chassis part carrying a number of successively arranged wheel assemblies;
wherein the two lateral chassis parts define a transport platform for a heavy load to be transported;
a central chassis part arranged between the two lateral chassis parts; and
wherein at least one of the two lateral chassis parts can be pivoted about a pivot axis that is relative to the central chassis part.

2. The heavy load transport vehicle according to claim 1, wherein each of the two lateral chassis parts are pivotable around their respective pivot axes that are relative to the central chassis part.

3. The heavy load transport vehicle according to claim 1, wherein the central chassis part comprises at least one central cross member segment of a cross member, which is connected with at least one lateral cross member segment of said cross member.

4. The heavy load transport vehicle according to claim 3, wherein at least one of the two lateral chassis parts comprise at least one further cross member which is pivotally connected with the central chassis part.

5. The heavy load transport vehicle according to claim 3, wherein the central chassis part has a longitudinal carrier which is connected with the central cross member segment of the cross member, and wherein at least one of the two lateral chassis parts comprise at least one lateral longitudinal carrier which is connected with at least one lateral cross member segment, and that the cross member or the central cross member segments are connected via a hinge with the lateral cross member segment.

6. The heavy load transport vehicle according to claim 5, wherein the at least one lateral longitudinal carrier of at least one lateral chassis part or at least one of the further cross members is connected with the central chassis part via a further hinge.

7. The heavy load transport vehicle according to claim 1, wherein at least one lateral chassis part is designed changeable in its width.

8. The heavy load transport vehicle according to claim 1, wherein at least one lateral chassis part comprises an outer longitudinal carrier.

9. The heavy load transport vehicle according to claim 1, including at least one support assembly having at least one support unit protruding from at least one of the lateral chassis parts.

10. The heavy load transport vehicle according to claim 9, wherein the at least one support assembly has at least two support units.

11. The heavy load transport vehicle according to claim 9, wherein the at least one support unit has an arm which is connected or can be connected with its first end to the transport vehicle, and that the arm has on its other end a roll or a sliding element.

12. The heavy load transport vehicle according to claim 1, wherein the central chassis part is wheel-less.

13. A variable width heavy load transport vehicle, comprising:
a central chassis part disposed between a right and a left lateral chassis part;
wherein the right and left lateral chassis parts each carry a number of successively arranged wheel assemblies;
wherein the right and the left lateral chassis parts define a transport platform for a heavy load to be transported;
wherein the left chassis part is pivotally connected to a left side of the central chassis part; and
wherein the right chassis part is pivotally connected to a right side of the central chassis part.

14. The heavy load transport vehicle according to claim 13, wherein the central chassis part is wheel-less.
